(19) United States
(12) Patent Application Publication
(10) Pub. No.: US 2011/0051579 A1
(43) Pub. Date: Mar. 3, 2011

(54) METHOD FOR CALIBRATING SIGNAL OFFSETS ON LIGHTSCRIBE DISC

(76) Inventors: Chun-Wen Lai, Taoyuan County (TW); Chi-Hsiang Kuo, Taoyuan County (TW)

(21) Appl. No.: 12/868,732

(22) Filed: Aug. 26, 2010

(30) Foreign Application Priority Data
Aug. 31, 2009 (TW) 098129345

(51) Int. Cl. G11B 20/18

(52) U.S. Cl. 369/53.35; G9B/20.046

(57) ABSTRACT

A method for calibrating signal offsets on a lightscribe disc is provided. Spoke signals of an inner ring are utilized as a counter in order to read information pattern signals of an outer ring in a predetermined marked area. Measure the signal offsets of the information pattern signals. Check whether the number of the spoke signals of the inner ring exceeds a predetermined value. When the number of the spoke signals does not exceed the predetermined value, continue to measure the signal offsets; and when the number of the spoke signals reaches the predetermined value, calculate an average signal offset. The signal offsets of the information pattern signals of the outer ring can be calibrated by utilizing the average signal offset during a radial calibration or a decoding calibration.

### BACKGROUND OF THE INVENTION

1. Field of the Invention

The present invention relates to a disc drive, and more particularly, to a method for calibrating signal offsets of an inner ring and an outer ring in control feature zones of a label side on a lightscribe disc.

2. Description of the Prior Art

A disc usually has two sides, wherein one side is used as a data side and the other side is used as a label side. A conventional method of producing labels on the disc is to make a mark on the label side by use of a pen or a label sticker as an identification. Recently, a lightscribe label technology has been developed. A user can carve desired patterns or texts on the label side of a lightscribe disc by use of a pick-up head of a disc drive to emit a laser light on the lightscribe disc, such that a beautiful and personalized disc can be produced.

Please refer to FIG. 1 (including 1A and 1B), which is a diagram illustrating how a conventional disc drive reads a signal in a control feature zone on a lightscribe disc. As shown in 1A, a control feature zone 11 of a lightscribe disc 10 includes an outer ring 12 and an inner ring 13 equipped with 400 spokes, wherein these spokes are evenly distributed in the inner ring 13 of the control feature zone 11 with equal angles. An optical encoder 14 is fixed in the disc drive 15. The optical encoder 14 sends out a beam irradiated on the inner ring 13 in order to produce spoke signals shown in 1B, and then provides angular dimensions to describe relative positions on the label side 17 during drawing operations to an pick-up head 16. The outer ring 12 provides related information patterns of the lightscribe disc 10, such as a media ID field, a saw-tooth mark, or an index mark. The information patterns of the outer ring 12 read by the pick-up head 16 form the information pattern signals shown in 1B. In the specification of the lightscribe disc 10, the start position of the spoke signals is set to follow the end of the index mark of the outer ring 12. For this reason, the disc drive 15 must find out the start position of the spoke signals by use of the signals within the inner ring 13 and the outer ring 12 simultaneously when the lightscribe disc 10 is inserted into the disc drive 15 for drawing marks on the label side 17. After the start position of the spoke signals is confirmed, the disc drive 15 can know the rotation angle of the lightscribe 10 and the information pattern signals of the outer ring 12 are currently read by the pick-up head 16 as long as the disc drive 15 counts the number of the spoke signals in the inner ring 13 continuously.

However, the optical encoder 14 and the pick-up head 16 are two individual components, wherein each component has different electrical signals with different processing speeds to cause a delay or a lead accordingly. As shown in 1B, the generated information pattern signals of the outer ring and the spoke signals of the inner ring are not synchronized, where an offset “d” is existed. Furthermore, manufacturing errors and manufacturing quality of the lightscribe disc will also lead to a problem that the information pattern signals of the outer ring can not be entirely aligned with the spoke signals of the inner ring defined in the specifications. Warping or irregularities occurred on the disc will also cause the signal offsets between the spoke signals of the inner ring and the information pattern signals of the outer ring more obvious. As a result, the read information pattern signals in the outer ring cannot be decoded successfully, or the pick-up head is unable to accurately achieve the radial calibration, thereby affecting the accuracy of the follow-up label-drawings. Hence, there are still problems to be solved upon calibrations of the signals of the inner ring and the outer ring read by the disc drive.

### SUMMARY OF THE INVENTION

It is one of the objectives of the present invention to provide a method for calibrating signal offsets on a lightscribe disc to solve the abovementioned problems. By measuring all signal offsets between information patterns of the outer ring and spoke signals of the inner ring within a marked area in order to calculate an average signal offset, the signal offsets between the signals of the outer ring and the inner ring can be calibrated by reference to the average signal offset.

It is another one of the objectives of the present invention to provide a method for calibrating signal offsets on a lightscribe disc to reduce a total signal offset by using the average signal offset obtained from information patterns of the outer ring and the spoke signals of the inner ring.

In order to achieve the abovementioned objectives, the method for calibrating signal offsets on a lightscribe disc disclosed in the present invention includes the following steps: utilizing spoke signals of an inner ring as a counter in order to read information pattern signals of an outer ring in a predetermined marked area; measuring the signal offsets; checking whether a number of the spoke signals of the inner ring exceeds a predetermined value; when the number of the spoke signals of the inner ring does not exceed the predetermined value, continue to measure the signal offsets; when the number of the spoke signals reaches the predetermined value, calculate an average signal offset; and calculating the signal offsets of the information pattern signals of the outer ring by utilizing the average signal offset.

In one embodiment of the present invention, the predetermined marked area can be a saw-tooth mark and a media ID mark, a single media ID mark, or a first part or a second part of a saw-tooth mark.

In one embodiment, the step of measuring the signal offsets includes the following steps: counting time with a timer, wherein the timer is started after being zeroed; starting the timer when the information pattern signals of the outer ring are generated; stopping the timer when the spoke signals of the inner ring are generated; and calculating the signal offsets by using a time difference between the start of the timer and the stop of the timer. Herein the step of calculating the signal offsets includes the following sub-steps: measuring a unit time of a single spoke signal of the inner ring; comparing the time difference with a half of the unit time; when the time difference is smaller than the half of the unit time, setting the time difference as a leading signal offset; and when the time difference is not smaller than the half of the unit time, setting a delay signal offset by subtracting the time difference from the unit time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 (including 1A and 1B) is a diagram illustrating how a conventional disc drive reads a signal in a control feature zone on a lightscribe disc.

FIG. 2 is a diagram of partial enlargement for a control feature zone on a lightscribe disc.

FIG. 3 is a diagram illustrating a delay signal offset of reading a saw-tooth information pattern according to an embodiment of the present invention.

FIG. 4 is a diagram illustrating a leading signal offset of reading a saw-tooth information pattern according to an embodiment of the present invention.

FIG. 5 is a diagram illustrating the signal offsets between the information pattern signals and the spoke signals according to an embodiment of the present invention.

FIG. 6 (including 6A and 6B) is a diagram illustrating how to measure the signal offsets of the information pattern signals according to an embodiment of the present invention.

FIG. 7 is a flowchart illustrating a method for calibrating signal offsets on a lightscribe disc according to an exemplary embodiment of the present invention.

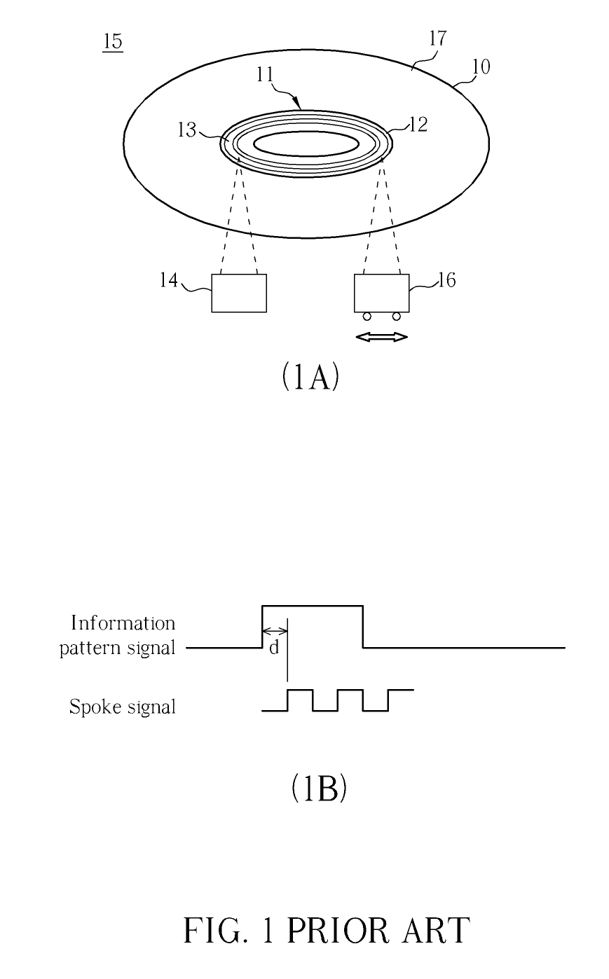

### DETAILED DESCRIPTION

In order to achieve the abovementioned objectives of the present invention, the adopted technical means and effects are described below by using given embodiments together with drawings.

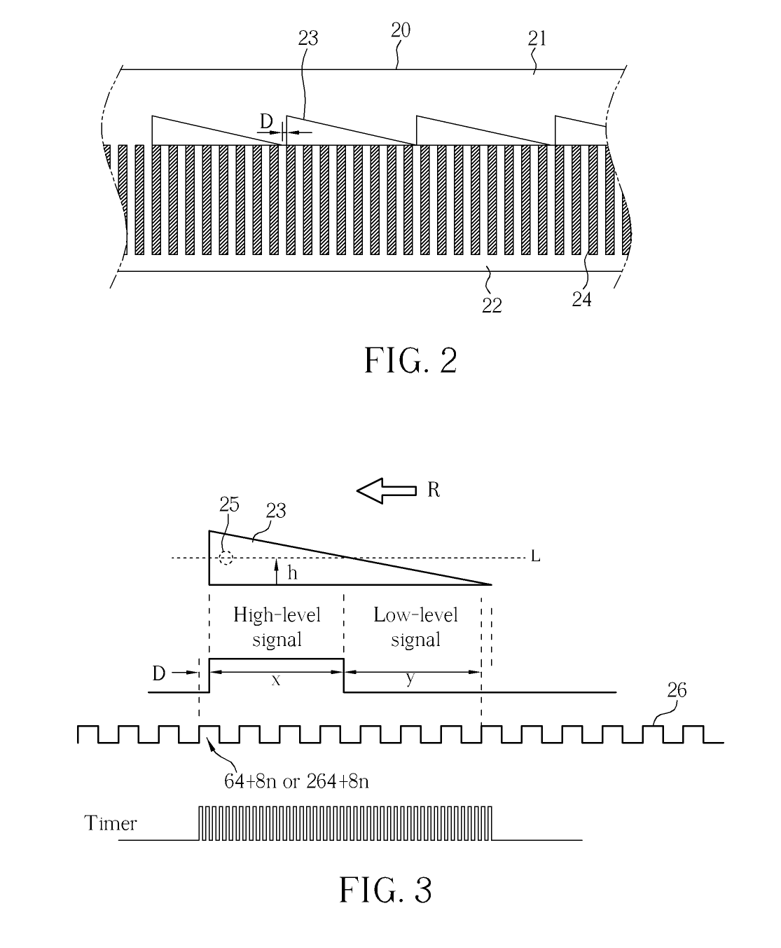

Please refer to FIG. 2, which is a diagram of partial enlargement for a control feature zone of a lightscribe disc. A control feature zone 20 includes an outer ring 21 and an inner ring 22, wherein the outer ring 21 includes information patterns 23 in multiple marked areas of the lightscribe disc, and the inner ring 22 has spokes 24 located side by side. In the specification of the lightscribe disc, the start position of each information pattern 23 in the outer ring 21 is set to be aligned with a specific spoke 24 and cover a specific amount of spoke 24 as the signal interpretation area. Take a saw-tooth maker as an example. The saw-tooth maker is divided into a first part and a second part, wherein each part has eight saw-tooth information pattern signals. The saw-tooth information pattern signals of the first part are started from the 64^{th} spoke 24, each saw-tooth information pattern covering eight spokes; while the saw-tooth information pattern signals of the second part are started from the 264^{th} spoke 24, each saw-tooth information pattern covering eight spokes 24. For this reason, manufacturing errors and manufacturing quality of the lightscribe disc will lead to a problem that the information pattern signals 23 of the outer ring 21 cannot be entirely aligned with the spoke signals 24 of the inner ring 22 to cause a signal offset D, thereby affecting the accuracy of the signal interpretation area.

As shown in FIG. 3, which is a diagram illustrating a delay signal of reading a saw-tooth information pattern 23 according to an embodiment of the present invention. When reading the saw-tooth information pattern 23, the lightscribe disc is rotated with a rotation direction R and a beam 25 of the pick-up head is radiated on a line L. When the spoke signal 26 of the inner ring is counted to the (64+8n)^{th} spoke signal or the (264+8n)^{th} spoke signal, the beam 25 of the pick-up head reaches the saw-tooth pattern 23 and a read signal with level high is outputted until the beam 25 leaves the saw-tooth pattern 23. At this time, a signal length “x” corresponding to the high-level signal is calculated by using pulses of the disc drive. As long as the beam 25 of the pick-up head leaves the saw-tooth information pattern 23, the read signal with level low is outputted until the covered eight spoke signals end. At this time, a signal length “y” corresponding to the low-level signal is calculated by using pulses of the disc drive. A radial movement “h” of the beam 25 for the pick-up head can be calculated as a reference for radial movement calibration by using a ratio of the signal length “x” to the signal length “y”. However, the signal offset “D” is generated because the information pattern 23 cannot be aligned with the spoke signal. The delayed information pattern signal will end after eight spoke signals pass, which results in ending the reading signal to cut off the unfinished low-level signal and thereby reduce the signal length “y” of the low-level signal. As a result, the ratio of the signal length “x” of the high-level signal to the signal length “y” of the low-level signal is wrong, thereby affecting the accuracy of the radial calibration.

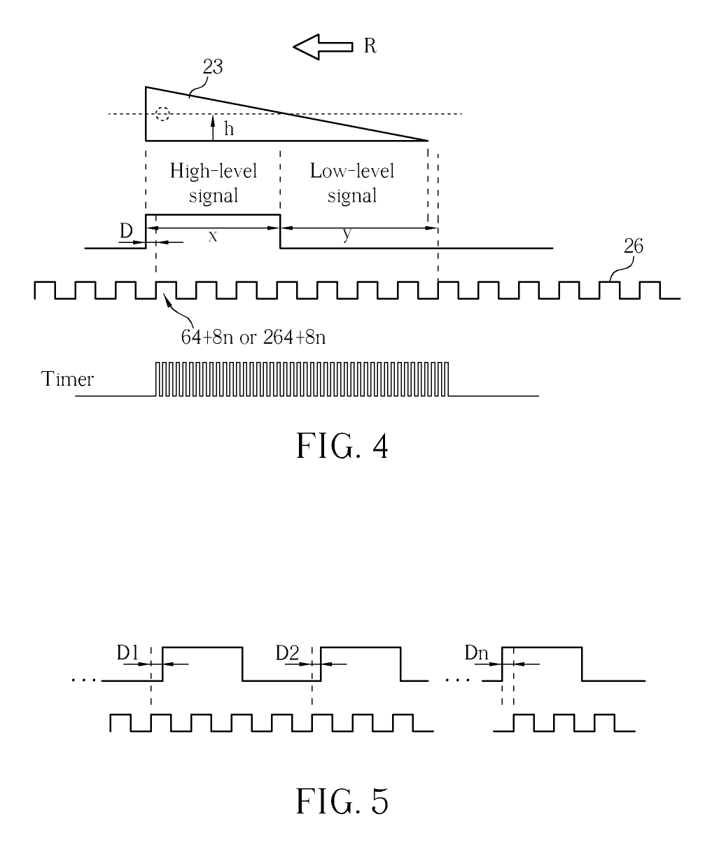

As shown in FIG. 4, which is a diagram illustrating a leading signal of reading a saw-tooth information pattern according to an embodiment of the present invention. However, the leading signal offset “D” is generated because the information pattern 23 cannot be aligned with the spoke signal. After the information pattern 23 ends, the eight spoke signals have not finished, which results in keeping reading the low-level signal to lengthen the low-level signal and thereby increase the signal length “y” of the low-level signal. As a result, the ratio of the signal length “x” of the high-level signal to the signal length “y” of the low-level signal is wrong. As long as the ratio of the signal length “x” of the high-level signal to the signal length “y” of the low-level signal changes, the radial movement “h” also changes, thereby affecting the accuracy of the radial calibration.

As shown in FIG. 5, which is a diagram illustrating the signal offset between the information pattern signals and the spoke signals according to an embodiment of the present invention. The signal offset “D” between each information pattern and its corresponding spoke signal are different from each other. As long as the information pattern changes, the accuracy will be changed, which results in a problem that sequential labels cannot be aligned. Hence, according to an embodiment of the present invention, all of the signal offsets D1, D2, D3, . . . , and Dn between information patterns and corresponding spoke signals are measured, in order to calculate an average signal offset DA=(D1+D2+D3+ . . . +Dn)/n as a reference for calibrating the signal offsets between information patterns and corresponding spoke signals. As a result, the signal length “x” of the high-level signal and the signal length “y” of the low-level signal can be maintained at a certain relationship so as to improve the accuracy of calibration.

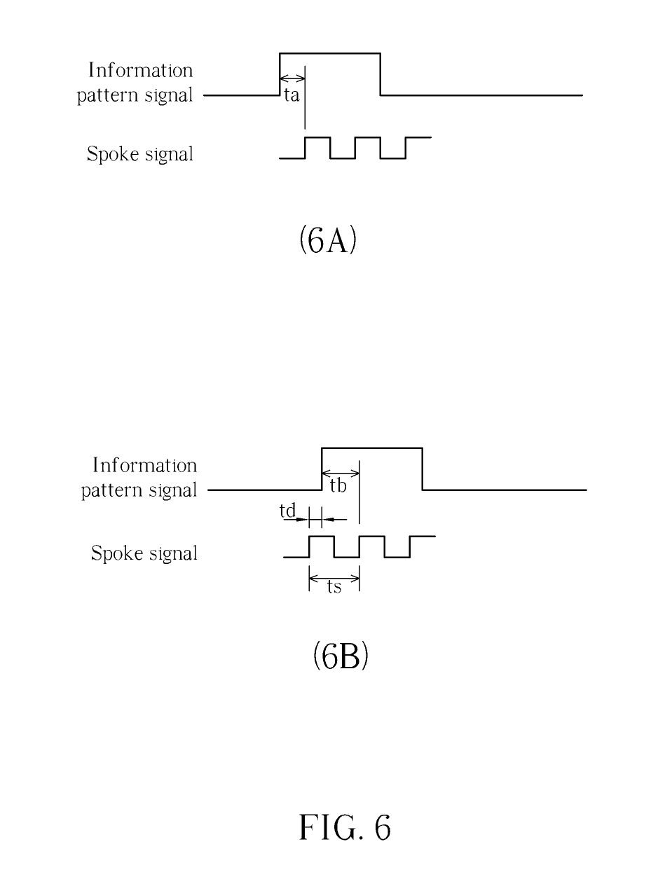

Please refer to FIG. 6 (including 6A and 6B), which is a diagram illustrating how to measure the leading signal offset or the delayed signal offset of the information pattern signals according to an embodiment of the present invention. First, a unit time “ts” of a single spoke signal is measured. A timer is zeroed before starting to count time. Start the timer when the information pattern signals of the outer ring are generated; and stop the timer when the spoke signals of the inner ring are generated. As shown in 6A, which indicates a leading signal offset existed in the information pattern signal. First, the timer is zeroed. Start the timer when the information pattern signals of the outer ring are generated; and stop the timer when the spoke signals of the inner ring are generated. Calculate the signal by measuring a time difference between the starting of the timer and the stopping of the timer. Finally, compare the time difference with a half of the unit time “ts” (i.e., ts/2). When the time difference is smaller than ts/2, it indicates a leading signal offset “ta”. As shown in 6B, which indicates a delayed signal offset existed in the information pattern signal. First, the timer is zeroed. Start the timer when the information pattern signals of the outer ring are generated; and stop the timer when the spoke signals of the inner ring are generated. Calculate the signal offsets by measuring a time difference between the start of the timer and the stop of the timer. Finally, compare the time difference “tb” with a half of the unit time “ts” (i.e., ts/2). When the time difference “tb” is not smaller than the half of the unit time (i.e., ts/2), set a delayed signal offset “td” by subtracting the time difference “tb” from the unit time “ts”, which is expressed as: td=ts−tb.

The abovementioned embodiments cite the saw-tooth information pattern as an example for describing features of the present invention, but the present invention is not limited to this only. When reading information patterns in a media ID mark, each square information pattern containing two spoke signals, the high-level signal of the information pattern is viewed as a digital signal “1” and the low-level signal is viewed as a digital signal “0”. If the signal length of the high-level signal is smaller than a predetermined length, it cannot be captured as a valid signal. As a result, the signal offset resulted from a condition that the information pattern cannot be aligned with the spoke signal will cause a change in the signal length of the high-level signal, thereby affecting the accuracy of decoding the media ID mark. In other words, the method for calibrating the signal offsets of a saw-tooth mark is suitable for the media ID mark as well.

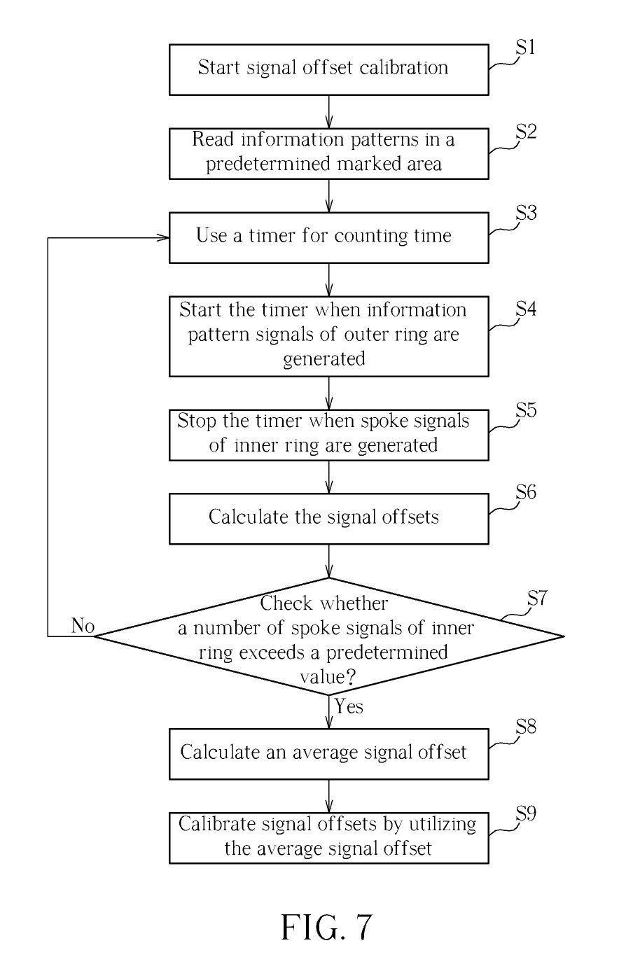

Please refer to FIG. 7, which is a flowchart illustrating a method for calibrating signal offsets on a lightscribe disc according to an exemplary embodiment of the present invention. The detailed steps for calibrating the signals of the outer ring according to the average signal offset are listed below. First, in the step S1, start to perform the signal offset calibration upon the lightscribe disc. In the step S2, spoke signals of the inner ring are utilized as a counter in order to read information pattern signals of the outer ring in a predetermined marked area; wherein the predetermined marked area can be a first part or a second part of a saw-tooth mark or a media ID mark. In the step S3, the timer is used for counting time. The step of counting time can be started after the timer is zeroed, or the step of counting time can be implemented by counting a number of pulses. In the step S4, start the timer when the information pattern signals of the outer ring are generated. In the step S5, stop the timer when the spoke signals of the inner ring are generated. In the step S6, calculate the signal offsets. In the step S7, check whether the number of the spoke signals of the inner ring exceeds a predetermined value. If the number of the spoke signals does not exceed the predetermined value, go back to the step S3; and if the number of the spoke signals reaches the predetermined value, go to the step S8. In the step S8, calculate an average signal offset. Finally, in the step S9, the signal offsets of the information pattern signals of the outer ring are calibrated by utilizing the average signal offset during a radial calibration or a decoding calibration.

In summary, the present invention provides a method for calibrating signal offsets on a lightscribe disc. By measuring signal offsets between information patterns of the outer ring and corresponding spoke signals of the inner ring within a marked area in order to calculate an average signal offset, the signal offsets between the signals of the outer ring and the inner ring can be calibrated by reference to the average signal offset. As a result, a total signal offset can be reduced, the synchronization of the signals in the outer ring and the inner ring can be improved, and the failure of radial calibration can be avoided, such that the pick-up head can be correctly moved in order to facilitate the label-drawings on the lightscribe disc.

Those skilled in the art will readily observe that numerous modifications and alterations of the device and method may be made while retaining the teachings of the invention.

What is claimed is:

1. A method for calibrating signal offsets on a lightscribe disc, comprising the following steps:
utilizing spoke signals of an inner ring as a counter in order to read information pattern signals of an outer ring in a predetermined marked area;
measuring the signal offsets;
checking whether a number of the spoke signals of the inner ring exceeds a predetermined value;
when the number of the spoke signals of the inner ring does not exceed the predetermined value, continue to measure the signal offset;
when the number of the spoke signals reaches the predetermined value, calculate an average signal offset; and
calculating the signal offsets of the information pattern signals of the outer ring by utilizing the average signal offset.

2. The method for calibrating the signal offsets on the lightscribe disc of claim 1, wherein the predetermined marked area is a saw-tooth mark.

3. The method for calibrating the signal offsets on the lightscribe disc of claim 2, wherein the predetermined marked area is a first part or a second part of the saw-tooth mark.

4. The method for calibrating the signal offsets on the lightscribe disc of claim. 3, wherein each part of the saw-tooth mark comprises eight saw-tooth information pattern signals used for calculating the average signal offset.

5. The method for calibrating the signal offsets on the lightscribe disc of claim 1, wherein the predetermined marked area is a media ID mark.

6. The method for calibrating the signal offsets on the lightscribe disc of claim 1, wherein the predetermined marked area comprises a saw-tooth mark and a media ID mark.

7. The method for calibrating the signal offsets on the lightscribe disc of claim 1, wherein the step of measuring the signal offset comprises the following steps:
counting time with a timer;
starting the timer when the information pattern signals of the outer ring are generated;
stopping the timer when the spoke signals of the inner ring are generated; and
calculating the signal offsets by using a time difference between the start of the timer and the stop of the timer.

8. The method for calibrating the signal offsets on the lightscribe disc of claim 7, wherein the timer is zeroed before starting to count time.

9. The method for calibrating the signal offsets on the lightscribe disc of claim 7, wherein the step of counting time with the timer comprises:
counting a number of pulses.

10. The method for calibrating the signal offsets on the lightscribe disc of claim 7, wherein the step of calculating the signal offset comprises the following sub-steps:
measuring a unit time of a single spoke signal of the inner ring;
comparing the time difference with a half of the unit time;
when the time difference is smaller than the half of the unit time, setting the time difference as a leading signal offset; and
when the time difference is not smaller than the half of the unit time, setting a delay signal offset by subtracting the time difference from the unit time.

11. The method for calibrating the signal offsets on the lightscribe disc of claim 1, wherein the information pattern signals of the outer ring are calibrated by utilizing the average signal offset during a radial calibration or a decoding calibration.
